(19) United States
(12) Patent Application Publication
(10) Pub. No.: US 2011/0243385 A1
(43) Pub. Date: Oct. 6, 2011

(54) Moving object detection apparatus, moving object detection method, and program

(75) Inventors: Katsuaki Nishino, Kanagawa (JP); Nobuhiro Tsunashima, Kanagawa (JP)

(73) Assignee: Sony Corporation, Tokyo (JP)

(21) Appl. No.: 13/065,374

(22) Filed: Mar. 21, 2011

(30) Foreign Application Priority Data
Mar. 30, 2010 (JP) P2010-079652

(51) Int. Cl. G06K 9/00

(52) U.S. Cl. 382/103

(57) ABSTRACT

Disclosed herein is a moving object detection apparatus including: an image input processing section configured to input an analysis image composed of an image taken by a camera in order to establish a designated region inside the analysis image; a first detection processing section configured to detect an image of a moving object which moves within the designated region established by the image input processing section and which is at a distance in a first range from the camera; and a second detection processing section configured to detect an image of the moving object which moves within the designated region established by the image input processing section and which is at a distance in a second range from the camera, the second range being farther than the first range.

### BACKGROUND OF THE INVENTION

1. Field of the Invention

The present invention relates to a moving object detection apparatus, a moving object detection method, and a program. More particularly, the invention relates to a moving object detection apparatus, a moving object detection method, and a program for ensuring moving object detection with sufficient accuracy even in dark places, typically at night.

2. Description of the Related Art

There already exist surveillance systems that monitor a predetermined space using surveillance cameras. Such surveillance systems typically use the image taken by each surveillance camera as an analysis image of which the data is to be analyzed, thereby detecting the image of a moving object moving in a designated region inside the analysis image of interest. Traditionally, most of these surveillance systems utilize the technique for detecting images of the moving object using a moving vector (e.g., see Japanese Patent Laid-open No. 2006-260049), or the technique for detecting the moving object by use of correlations between current and past images (e.g., see Japanese Patent No. 3506934 and Japanese Patent Laid-open No. 2007-251721).

### SUMMARY OF THE INVENTION

From the nature of security, the surveillance system is required to ensure detection with at least a certain level of accuracy so that objects being monitored will not be missed or erroneously detected even in dark places, typically at night. However, the requirement has yet to be met sufficiently by traditional techniques for moving object detection, including those cited above.

The present invention has been made in view of the above circumstances and provides innovative arrangements for ensuring moving object detection with sufficient accuracy even in dark places, typically at night.

In carrying out the present invention and according to one embodiment thereof, there is provided a moving object detection apparatus including: image input processing means for inputting an analysis image composed of an image taken by a camera in order to establish a designated region inside the analysis image; first detection processing means for detecting an image of a moving object which moves within the designated region established by the image input processing means and which is at a distance in a first range from the camera; and second detection processing means for detecting an image of the moving object which moves within the designated region established by the image input processing means and which is at a distance in a second range from the camera, the second range being farther than the first range from the camera. In the moving object detection apparatus, the second detection processing means selectively uses either moving vector determination or correlation determination as a processing technique for detecting the image of the moving object at the distance in the second range, the moving vector determination involving determining whether there exists the moving object using a moving vector, the correlation determination involving determining whether there exists the moving object using correlations between past and current images.

Preferably, the second detection processing means may include: processing technique selection means for selecting either the moving vector determination or the correlation determination as the processing technique based on predetermined parameter; moving vector determination means configured such that if the moving vector determination is determined to be the processing technique by the processing technique selection means, then the moving vector determination means may detect the image of the moving object at the distance in the second range in accordance with the moving vector determination; and correlation determination means configured such that if the correlation determination is determined to be the processing technique by the processing technique selection means, then the correlation determination means may detect the image of the moving object at the distance in the second range in accordance with the correlation determination.

Preferably, the second detection processing means may include brightness determination means as the predetermined parameter for use by the processing technique selection means for determining whether the brightness of the designated region is below a predetermined level; wherein, if the brightness of the designated region is determined to be above the predetermined level by the brightness determination means, then the processing technique selection means may select the moving vector determination as the processing technique; and wherein, if the brightness of the designated region is determined to be below the predetermined level by the brightness determination means, then the processing technique selection means may select the correlation determination as the processing technique.

Preferably, the moving object detection apparatus of the invention may further include external input means for inputting externally the parameter for use by the processing technique selection means; wherein, based on the parameter input by the external input means, the processing technique selection means may select either the moving vector determination or the correlation determination as the processing technique.

Preferably, the second detection processing means may have a plurality of ranges established for the distance to the moving object to be detected; and independently in each of the plurality of ranges, the second detection processing means may select either the moving vector determination or the correlation determination as the processing technique to be used.

According to other embodiments of the present invention, there is provided a moving object detection method representing the functionality of the above-outlined moving object detection apparatus of the invention, as well as a program functionally equivalent to the inventive moving object detection method.

Where the moving object detection apparatus, moving object detection method, or program according to the embodiments of the present invention is in use, an analysis image taken by a camera is input in order to establish a designated region inside the analysis image. An image is detected of a moving object moving within the established designated region at a distance in a first range from the camera. An image is also detected of the moving object moving within the established designated region at a distance in a second range from the camera, the second range being farther than the first range. Either moving vector determination or correlation determination is used selectively as a processing technique for detecting the image of the moving object at the distance in the second range, the moving vector determination involving determining the presence of the moving object using a moving vector, the correlation determination involving determining the presence of the moving object using correlations between past and current images.

According to the present invention embodied as outlined above, it is possible to ensure moving object detection with sufficient accuracy even in dark places, typically at night.

### BRIEF DESCRIPTION OF THE DRAWINGS

Further features and advantages of the present invention will become apparent upon a reading of the following description and appended drawings in which:

FIG. 1 is a block diagram showing a functional structure of an image analysis apparatus;

FIG. 2 is a schematic view showing a typical analysis image subject to an image analysis process;

FIG. 3 is a schematic view showing typically divided search ranges;

FIG. 4 is a schematic view showing a typical moving vector search range;

FIG. 5 is a schematic view showing a typical detection region;

FIG. 6 is a flowchart explanatory of a typical image analysis process;

FIG. 7 is a flowchart explanatory of a typical short-distance detection process;

FIG. 8 is a flowchart explanatory of a typical long-distance detection process;

FIG. 9 is a block diagram showing a typical functional configuration of a surveillance system including as one of its components an image analysis apparatus embodying the present invention;

FIG. 10 is a block diagram showing a typical functional configuration of a system including as one of its components the image analysis apparatus embodying the present invention;

FIG. 11 is a block diagram showing a typical functional configuration of another system including as one of its components the image analysis apparatus embodying the present invention;

FIG. 12 is a schematic view showing a typical processing technique applicable to each of four segmented search ranges;

FIG. 13 is a block diagram showing another functional structure of the image analysis apparatus;

FIG. 14 is a schematic view explanatory of a specific example in which processing techniques are switched by use of an external input section; and

FIG. 15 is a block diagram showing a typical hardware structure of a moving object detection apparatus to which the present invention is applied.

### DETAILED DESCRIPTION OF THE PREFERRED EMBODIMENTS

The moving object detection apparatus to which the present invention is applied will now be described below in two types (called the first and the second embodiments hereunder). The description will be given under the following headings:

1. First embodiment (an example in which the processing techniques are switched based on the brightness of the analysis image).

2. Second embodiment (an example in which the processing techniques are switched using a switching instruction from the outside).

### 1. First Embodiment

### Functional Structure of the Image Analysis Apparatus

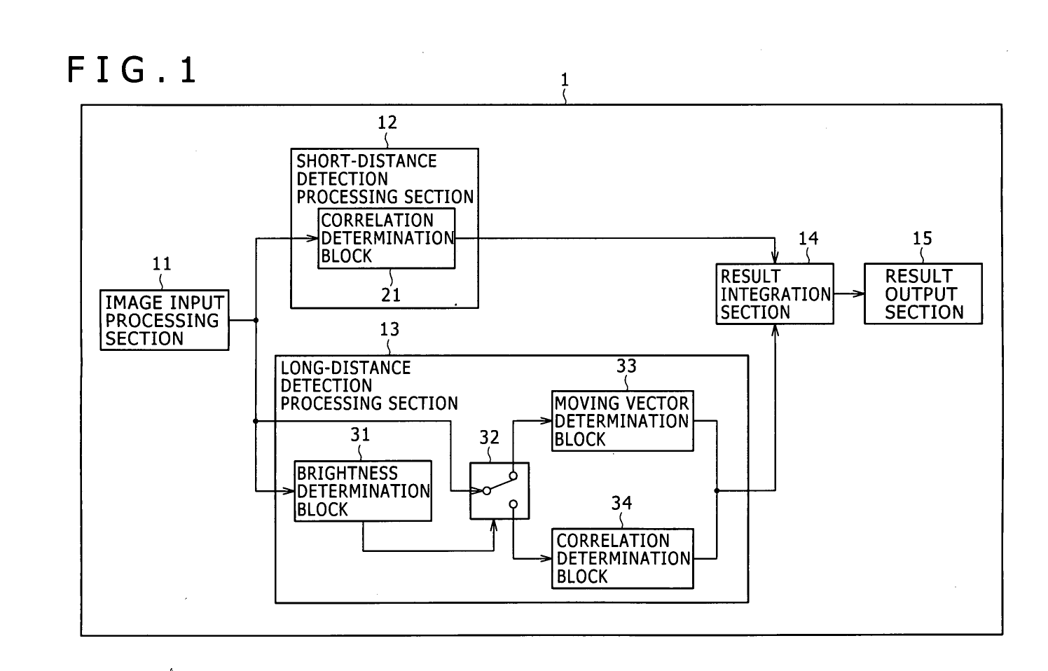

FIG. 1 is a block diagram showing a functional structure of an image analysis apparatus 1 as an embodiment of the moving object detection apparatus to which the present invention is applied.

The image analysis apparatus 1 of FIG. 1 uses an image taken by a surveillance camera of the surveillance system as an analysis image of which the data is to be analyzed, in order to determine whether an image of a moving object has moved in a region designated inside the analysis image of interest (the region will be called the designated region hereunder). The series of these steps above will be called the image analysis process hereunder.

Designed to perform the image analysis process, the image analysis apparatus 1 is made up of an image input processing section 11, a short-distance detection processing section 12, a long-distance detection processing section 13, a result integration section 14, and a result output section 15.

The image input processing section 11 inputs analysis image data from the outside. Inside the analysis image in question, the region designated typically by a user as the object under surveillance is established as the designated region FS.

### [Example of the Analysis Image]

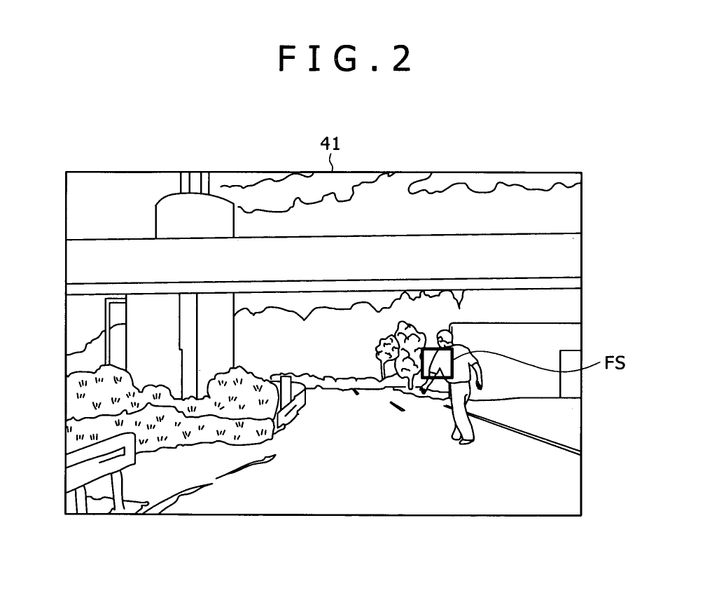

FIG. 2 is a schematic view showing a typical analysis image 41 subject to the image analysis process. In the analysis image 41 of FIG. 2, the designated region FS is established to the right of the center.

The image analysis apparatus 1 adopts a moving image as the subject of surveillance for moving object detection. The moving image is made up of a plurality of unit images such as frames or fields, the unit images being arrayed in a predetermined order to constitute the moving image. The data representing such unit images is input to the image input processing section 11 as analysis image data. That is, every time a unit image constituting part of a moving image is input, the first embodiment performs the image analysis process to determine whether there exists an image of the moving object.

Based on the analysis image data, the short-distance detection processing section 12 and long-distance detection processing section 13 detect whether a moving object image has moved in the designated region FS inside the analysis image of interest.

### [Typically Divided Search Ranges]

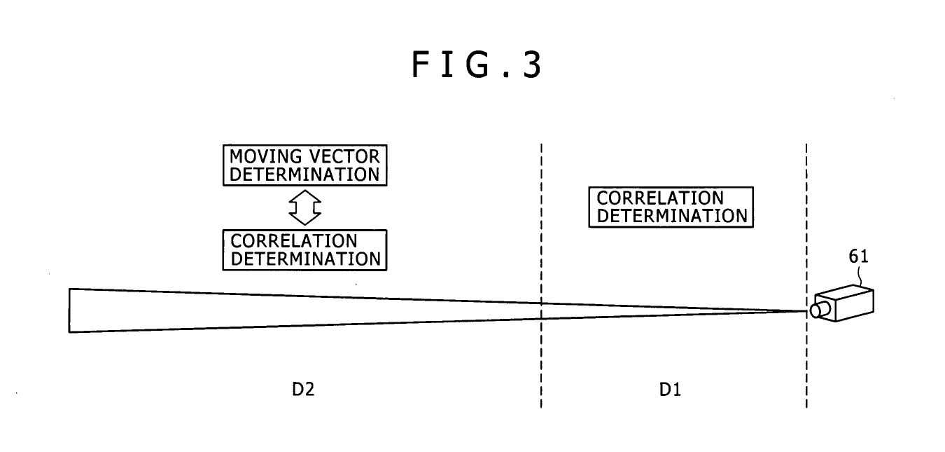

FIG. 3 shows typically divided search ranges taken on by the short-distance detection processing section 12 and long-distance detection processing section 13.

As shown in FIG. 3, if a moving object, not shown, moves in front of a surveillance camera 61 inside the designated region FS in a search range D1 at a short distance within a predetermined distance from the surveillance camera (i.e., at a distance in the first range), then an image of the moving object is detected by the short-distance detection processing section 12 acting as the first detection processing section to be described in the appended claims.

On the other hand, if the moving object (not shown) moves in front of the surveillance camera 61 inside the designated region FS (or probably inside a detection region FF to be discussed later, to be more precise) in a search range D2 at a long distance farther than the predetermined distance from the surveillance camera 61 (i.e., at a distance in the second range farther than the first range), then an image of the moving object is detected by the long-distance detection processing section 13 acting as the second detection processing section to be described in the appended claims.

The short-distance detection processing section 12 may adopt advantageously a technique for detecting the image of the moving object in question by determining whether the moving object image exists using correlations between current and past images. This technique will be called correlation determination hereunder. Where at least a certain amount of light is secured, typically in the daylight, the long-distance detection processing section 13 may advantageously adopt a technique for detecting the image of the moving object in question by determining whether the moving object image exists using a moving vector. This technique will be called moving vector determination hereunder. The reasons why these techniques may be utilized advantageously are explained below.

If the moving object to be detected is near the surveillance camera 61, the image of the moving object grows in size inside the designated region FS. Then if the speed of the movement is higher, the moving distance per unit time within the image becomes longer, which can make it difficult to obtain the moving vector. In such a case, the use of moving vector determination may result in a missed object during detection. By contrast, correlation determination entails a reduced possibility of such missed detection taking place because correlation determination involves utilizing correlations between past and current images inside the designated region FS. For these reasons, correlation determination is suitable for, and adopted by, the short-distance detection processing section 12 of the first embodiment.

That is, the short-distance detection processing section 12 includes a correlation determination block 21 for detecting an image of a moving object through correlation determination.

The correlation determination block 21 calculates the value Rzncc in the following expression (1) using data of the analysis image currently input by the image input processing section 11 (the image is called the current image) and data of the analysis image previously input by the image input processing section 11 (the image is called the past image):

$$Rzncc = \frac{\sum ( O - {O}_{avg} ) ( P - {P}_{avg} )}{\sqrt{\sum {( O - {O}_{avg} )}^{2} \sum {( P - {P}_{avg} )}^{2}}} \qquad ( 1 )$$

where, the value Rzncc denotes the coefficient of normalized cross correlation. Also in the expression (1) above, the value O represents each pixel value inside the detection region of the current image. In the process of the correlation determination block 21, the value O indicates each pixel value in the designated region FS of the current image. The value Oavg stands for an average of the pixel values inside the detection region of the current image. In the process of the correlation determination block 21, the value Oavg denotes the average of the pixel values in the designated region FS of the current image. The value P represents each pixel value inside the detection region of the past image. In the process of the correlation determination block 21, the value P indicates each pixel value in the designated region FS of the past image. The value Pavg stands for an average of the pixel values inside the detection region of the past image. In the process of the correlation determination block 21, the value Pavg denotes the average of the pixel values in the designated region FS of the past image.

The coefficient Rzncc of normalized cross correlation is small when the moving object is included in the detection region and is large when the moving object is not included in the detection region. Thus the correlation determination block 21 determines that an image of the moving object exists in the designated region FS if the coefficient Rzncc of normalized cross correlation is found smaller than, say, a predetermined threshold value, and that the image of the moving object does not exist in the designated region FS if the coefficient Rzncc of normalized cross correlation is found larger than the threshold value.

However, such correlation determination is not appropriate where the moving object to be detected is at a long distance from the surveillance camera 61. That is because the image of the moving object becomes smaller in size in the designated region FS the farther away from the surveillance camera 61. In such a case, the size of the moving object inside the designated region FS becomes about the same as that of the image of, say, the trees swaying near the surveillance camera 61. Thus with correlation determination, it is difficult to determine whether the moving object image included in the designated region FS is the image of the moving object to be detected or the image of the disturbances caused by the swaying trees or the like. Correlation determination may then result in faulty detection.

By contrast, moving vector determination entails a reduced possibility of such erroneous detection taking place because this technique involves acquiring the moving vector of the moving object image included in the designated region FS thereby making it easy to find the moving speed of the moving object image and its moving direction inside the designated region FS. For this reason, moving vector determination is principally suitable for, and adopted by, the long-distance detection processing section 13 of the first embodiment as the processing technique.

The wording “moving vector determination is principally suitable” means that it is suitable as the processing technique assuming that at least a certain amount of light is secured as in the daylight. The image taken by the surveillance camera 61 with an insufficient amount of light typically at night has a low level of brightness. The use of the data derived from such images at low levels of brightness worsens the accuracy of calculating the moving vector of the moving object image. As a result, the accuracy of detecting the moving object image declines.

According to the first embodiment, the long-distance detection processing section 13 adopts as its processing technique moving vector determination where the brightness of the analysis image is above a predetermined reference level, or takes up correlation determination where the brightness of the analysis image is below the reference level.

If the brightness of the analysis image is below the reference level, i.e., where there is an insufficient amount of light typically at night, the images of disturbances such as swaying trees are either not included in the analysis image or may be included but at far lower levels of brightness than the image of the moving object to be detected. It follows that where the brightness of the analysis image is below the reference level, there is practically no possibility of erroneously regarding the disturbances typically caused by swaying trees or the like as the image of the moving object. Thus correlation determination may be adopted by the long-distance detection processing section 13 with little fear of faulty detection as long as the brightness of the analysis image is below the reference level.

In the manner described above, the long-distance detection processing section 13 selects either moving vector determination or correlation determination as its processing technique based on the brightness of the analysis image. By use of the processing technique thus selected, the long-distance detection processing section 13 detects the image of the moving object.

Designed to function as discussed above, the long-distance detection processing section 13 is made up of a brightness determination block 31, a processing technique selection block 32, a moving vector determination block 33, and a correlation determination block 34, as illustrated in FIG. 1.

The brightness determination block 31 determines whether the brightness of the analysis image of interest in the designated region FS is below a predetermined reference level on the basis of the analysis image data output from the image input processing section 11. More specifically, the brightness determination block 31 counts the number of the pixels whose brightness values are below the reference level from among the pixels inside the designated region FS. If the pixel count thus obtained is above a predetermined threshold value, the brightness determination block 31 determines that the brightness in the designated region FS is below the reference level. If the pixel count is below the threshold value, then the brightness determination block 31 determines that the brightness in the designated region FS is above the reference level.

Based on the result of the determination by the brightness determination block 31, the processing technique selection block 32 selects either moving vector determination or correlation determination as the processing technique. That is, if the brightness determination block 31 determines that the brightness in the designated region FS is above the reference level, the processing technique selection block 32 selects moving vector determination as the processing technique and allows the analysis image data output from the image input processing section 11 to be supplied to the moving vector determination block 33. On the other hand, if the brightness determination block 31 determines that the brightness in the designated region FS is below the reference level, then the processing technique selection block 32 selects correlation determination as the processing technique and allows the analysis image data output from the image input processing section 11 to be sent to the correlation determination block 34.

The moving vector determination block 33 detects the image of the moving object in accordance with moving vector determination. For example, the moving vector determination block 33 establishes each of the pixels of the current image in the designated region FS successively as the pixel of interest so as to establish a block surrounding the pixels of interest in the current image (the block is called the block of interest). The moving vector determination block 33 then searches a past image for a block corresponding to the block of interest (the searched-for block is called the corresponding block). The moving vector determination block 33 proceeds to detect a vector ranging from the corresponding block to the block of interest through the current and past images being overlaid (in the same coordinate system) as the moving vector of the pixels of interest.

### [Example of the Moving Vector Search Range]

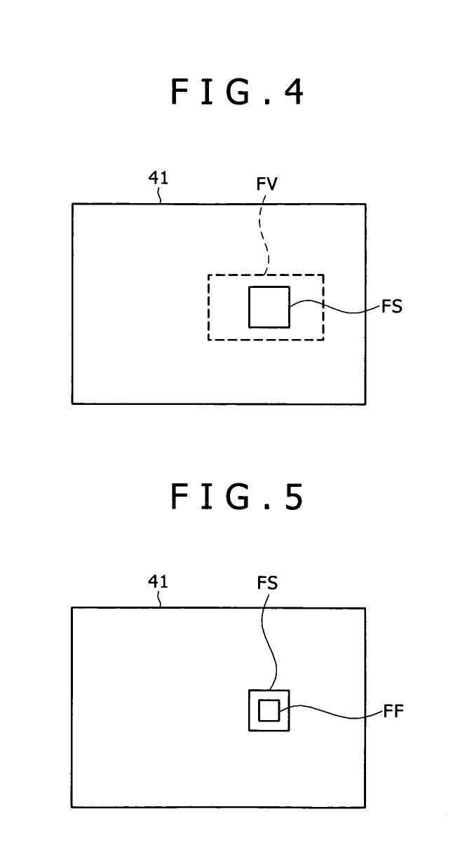

FIG. 4 shows a typical search range for the corresponding block, i.e., a typical moving vector search range. As shown in FIG. 4, a search range FV surrounds the designated region FS in the analysis image 41 and is set to be larger than the designated region FS. It should be noted that the search range FV in FIG. 4 is only an example. Any other desired range in the analysis image 41 may be adopted as the search range instead.

The above-described technique for detecting the moving vector is generally called block-matching algorithm. Needless to say, block-matching algorithm is only an example and other desired techniques such as gradient methods may be adopted instead.

The correlation determination block 34 detects the image of the moving object in accordance with correlation determination. That is, the correlation determination block performs basically the same process as the correlation determination block 21 of the short-distance detection processing section 12. It should be noted, however, that the detection region used to find the coefficient Rzncc of normalized cross correlation using the expression (1) above is different between the correlation determination block 34 of the long-distance detection processing section 13 and the correlation determination block 21 of the short-distance detection processing section 12.

### [Typical Detection Region Used to Find the Coefficient of Normalized Cross Correlation]

FIG. 5 shows a typical detection region used to find the coefficient Rzncc of normalized cross correlation. As discussed above, the correlation determination block 21 of the short-distance detection processing section 12 uses the designated region FS unchanged as the detection region. By contrast, the correlation determination block 34 of the long-distance detection processing section 13 utilizes the region FF smaller in size than the designated region FS as the detection region. When the detection region is made smaller in size, the image of the moving object to be detected becomes larger in size in reverse proportion. Then it is that much easier to detect the image of the moving object farther in the distance. With the detection region reduced in size, the correlation determination block 34 of the long-distance detection processing section 13 functions as long as the brightness is below the reference level. For this reason, there is virtually no possibility of faulty detection taking place due to the disturbances such as swaying trees.

Described above was the functional structure of the long-distance detection processing section 13 capable of choosing between moving vector determination and correlation determination. As shown in FIG. 1, the result of the detection performed by the long-distance detection processing section 13 is supplied to the result integration section 14 along with the result of the detection made by the short-distance detection processing section 12.

The result integration section 14 integrates the detection result coming from the short-distance detection processing section 12 with the detection result from the long-distance detection processing section 13, and sends the integrated result to the result output section 15. In turn, the result output section 15 outputs the integrated result as the definitive result of the detection carried out by the image analysis apparatus 1.

For example, if at least either the detection result from the short-distance detection processing section 12 or the detection result from the long-distance detection processing section 13 indicates a moving object having been detected, the result integration section 14 acquires the integrated result indicating that there is a moving object and causes the result to be output by the result output section 15.

On the other hand, if neither the detection result from the short-distance detection processing section 12 nor the detection result from the long-distance detection processing section 13 indicates a moving object having been detected, then the result integration section 14 acquires the integrated result indicating that there is no moving object and has the result output by the result output section 15.

### [Image Analysis Process]

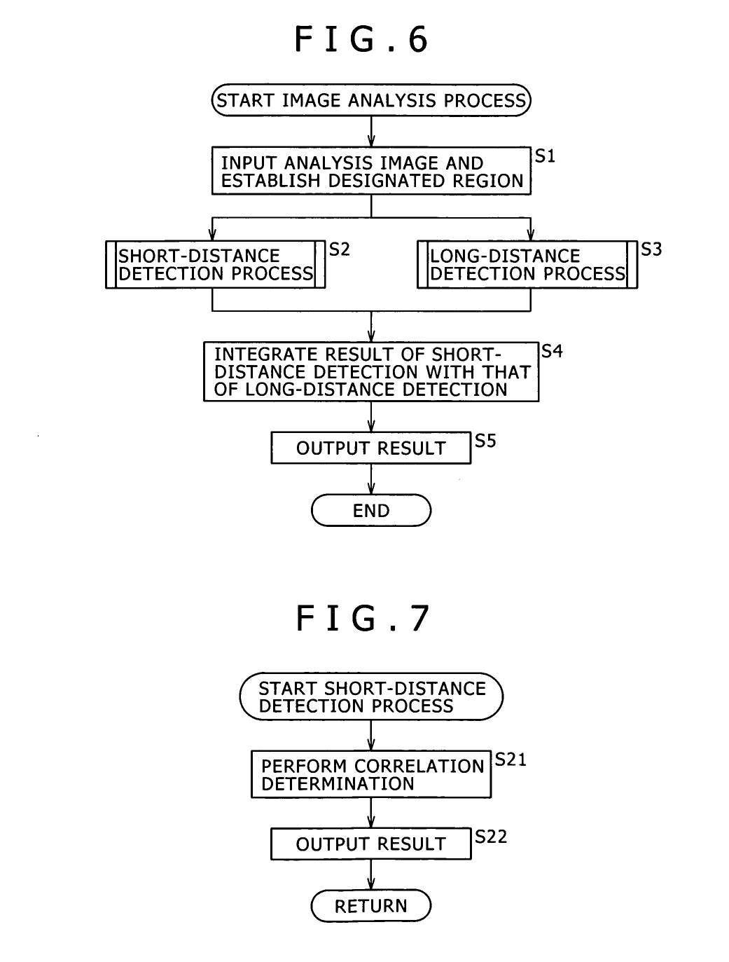

Explained below in reference to FIG. 6 is the image analysis process performed by the image analysis apparatus 1 having the functional structure described above.

FIG. 6 is a flowchart explanatory of a typical image analysis process.

As discussed above, the image analysis apparatus 1 adopts the moving image as the subject of surveillance for moving object detection. That moving image is composed of a plurality of unit images taken at predetermined intervals by the surveillance camera 61 in FIG. 3 or the like. Thus every time the data of each of these unit images constituting the moving image is output from the surveillance camera 61 in FIG. 3 or the like, the image analysis process is carried out.

In step S1, the image input processing section 11 of the image analysis apparatus 1 in FIG. 1 inputs the data of a unit image as the analysis image output from the surveillance camera 61 or the like, and establishes the designated region inside the analysis image in question.

In steps S2 and S3, the short-distance detection processing section 12 and long-distance detection processing section 13 perform a short-distance detection process and a long-distance detection process, respectively, in parallel.

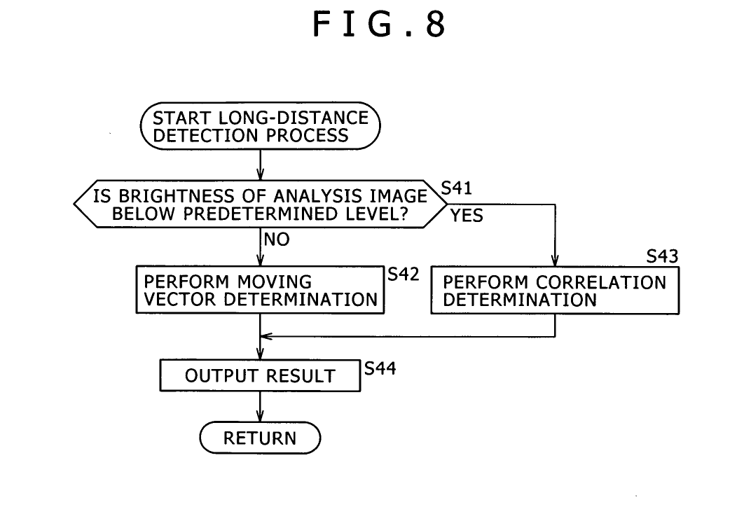

The short-distance detection process refers to a series of steps carried out by the short-distance detection processing section 12 until a moving object image is detected. The short-distance detection process will be discussed later in detail in reference to the flowchart of FIG. 7. The long-distance detection process refers to a series of steps performed by the long-distance detection processing section 13 until a moving object image is detected. The long-distance detection process will be explained later in detail in reference to the flowchart of FIG. 8.

In step S4, the result integration section 14 integrates the results of the short-distance detection process and long-distance detection process. That is, if the results of both the short-distance detection process and the long-distance detection process indicate that there is no moving object, the integrated result says there exists no moving object. If at least either the detection result from the short-distance detection processing section 12 or the detection result from the long-distance detection processing section 13 indicates that there is a moving object, then the integrated result says there exists a moving object.

In step S5, the result output section 15 outputs the integrated result obtained in step S4 as the definitive result of the detection performed by the image analysis apparatus 1. This step concludes the image analysis process.

### [Short-Distance Detection Process]

Explained below in reference to FIG. 7 is the short-distance detection process carried out by the short-distance detection processing section 12 of the image analysis apparatus 1 in FIG. 1 as part of the process in step S2 during the above-described image analysis process.

FIG. 7 is a flowchart explanatory of a typical short-distance detection process.

In step S21, the correlation determination block 21 of the short-distance detection processing section 12 performs correlation determination on the data of the analysis image input in step S1 of FIG. 6. Performing correlation determination means detecting a moving object image in accordance with correlation determination.

In step S22, the correlation determination block 21 outputs the result of the process of correlation determination in step S21.

If no moving object image is detected in the process of correlation determination in step S21, then the correlation determination block 21 goes to step S22 and outputs the result indicating that there is no moving object. This step concludes the short-distance detection process. In this case, if the result of a long-distance detection process in FIG. 8, to be discussed later, also indicates that there is no moving object, the definitive result of the image analysis process in FIG. 6 is output in step S5 indicating that there is no moving object. On the other hand, if the result of the long-distance detection process in FIG. 8 to be discussed later indicates that there is a moving object, then the definitive result of the image analysis process in FIG. 6 is output in step S5 indicating that there exists a moving object.

Meanwhile, if a moving object image is detected in the process of correlation determination in step S21, then the correlation determination block 21 goes to step S22 and outputs the result of the detection indicating that there is a moving object. This step concludes the short-distance detection process. In this case, the definitive result of the image analysis process in FIG. 6 is output in step S5 indicating that there exists a moving object.

After the result of the process in step S21 is output in step S22, control is transferred to step S4 in FIG. 6.

Explained above in reference to FIG. 7 was the short-distance detection process performed by the short-distance detection processing section 21 of the image analysis apparatus 1 in FIG. 1 as the process of step S2 in the image analysis process of FIG. 6. Described below in reference to FIG. 8 is the long-distance detection process carried out by the long-distance detection processing section 13 of the image analysis apparatus in FIG. 1 as the process of step S3 in the image analysis process.

### [Long-Distance Detection Process]

FIG. 8 is a flowchart explanatory of a typical long-distance detection process.

In step S41, based on the data of the analysis image input in step S1 of FIG. 6, the brightness determination block of the long-distance detection processing section 13 determines whether the brightness of the analysis image in question is above a predetermined reference level.

If the brightness determination block 31 determines that the brightness of the analysis image is above the reference level, then the processing technique selection block selects moving vector determination as the processing technique. The processing technique selection block 32 proceeds to supply the moving vector determination block 33 with the analysis image data input in step S1. In this case, the result of the determination in step S41 is negative (“NO”), and control is transferred to step S42.

In step S42, the moving vector determination block 33 performs moving vector determination on the analysis image data. Performing moving vector determination means detecting a moving object image in accordance with moving vector determination.

In step S44, the moving vector determination block outputs the result of the process of moving vector determination in step S42.

If no moving image data is detected in the process of moving vector determination in step S42, then the moving vector determination block 33 goes to step S44 and outputs the result indicating that there is no moving object. This step concludes the long-distance detection process. In this case, if the result of the above-described short-distance detection process in FIG. 7 also indicates that there is no moving object, the definitive result of the image analysis process in FIG. 6 is output in step; S5 indicating that there is no moving object. On the other hand, if the result of the short-distance detection process in FIG. 7 indicates that there is a moving object, then the definitive result of the image analysis process in FIG. 6 is output in step S5 indicating that there exists a moving object.

Meanwhile, if a moving object image is detected in the process of moving vector determination in step S42, then the moving vector determination block 33 goes to step S44 and outputs the result of the detection indicating that there is a moving object. This step concludes the long-distance detection process. In this case, the definitive result of the image analysis process in FIG. 6 is output in step S5 indicating that there exists a moving object.

Explained above was the process performed after the result of the determination in step S41 turns out to be negative (“NO”), i.e., the process executed when moving vector determination is carried out.

On the other hand, if the brightness determination block 31 determines that the brightness of the analysis image is below the reference level, then the processing technique selection block 32 selects correlation determination as the processing technique. The processing technique selection block 32 proceeds to supply the correlation determination block 34 with the analysis image data input in step S1. In this case, the result of the determination in step S41 is affirmative (“YES”), and control is transferred to step S43.

In step S43, the correlation determination block 34 performs correlation determination on the data of the analysis image. Performing correlation determination means detecting a moving object image in accordance with correlation determination.

In step S44, the correlation determination block 34 outputs the result of the process of correlation determination performed in step S43.

If no moving image data is detected in the process of correlation determination in step S43, then the correlation determination block 34 goes to step S44 and outputs the result indicating that there is no moving object. This step concludes the long-distance detection process. In this case, if the result of the above-described short-distance detection process in FIG. 7 also indicates that there is no moving object, the definitive result of the image analysis process in FIG. 6 is output in step S5 indicating that there is no moving object. On the other hand, if the result of the short-distance detection process in FIG. 7 indicates that there is a moving object, then the definitive result of the image analysis process in FIG. 6 is output in step S5 indicating that there exists a moving object.

Meanwhile, if a moving object image is detected in the process of correlation determination in step S43, then the correlation determination block 34 goes to step S44 and outputs the result of the detection indicating that there is a moving object. This step concludes the long-distance detection process. In this case, the definitive result of the image analysis process in FIG. 6 is output in step S5 indicating that there exists a moving object.

In step S44, the result of the process in step S42 or S43 is output. Control is then transferred to step S4 in FIG. 6.

As described, the image analysis apparatus 1 can distinguish between the moving object image at a short distance and the moving object image at a long distance when detecting the image of the moving object moving inside the designated region FS of the analysis image. More specifically, when detecting the image of the moving object at a short distance, the image analysis apparatus 1 always performs correlation determination. On the other hand, if the brightness of the analysis image is above the predetermined reference level, then the image analysis apparatus 1 detects the image of the moving object at the long distance in accordance with moving vector determination. This allows the image analysis apparatus 1 to remain robust against disturbances such as the images of swaying trees in a bright environment as in the daylight, thereby enabling the apparatus 1 to detect moving object images in stable fashion.

Also, when the brightness of the analysis image is below the reference level, the image analysis apparatus 1 switches the processing technique for detecting moving object images at long distances from moving vector determination to correlation determination. Correlation determination is more robust against brightness fluctuation than moving vector determination. Meanwhile, the disturbances such as swaying trees to which correlation determination is vulnerable are not imaged at all or may be imaged but at a very low level of brightness where the brightness of the analysis image is below the reference level in a dark environment such as at night. This provides for little possibility of faulty detection. Thus even if the brightness of the analysis image drops below the reference level in a dark environment such as at night, it is possible to secure stable detection of moving object images.

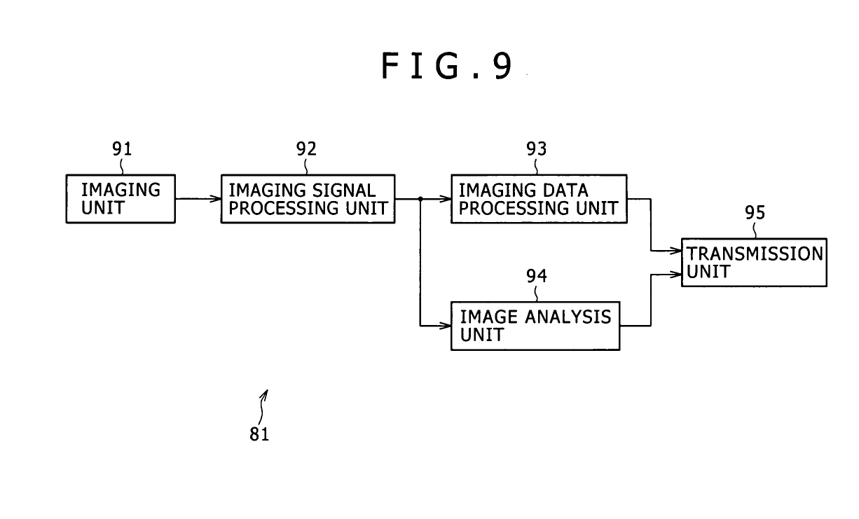

The image analysis apparatus 1 can be applied not only to the surveillance system discussed above but also to other diverse fields. A few typical applications of the image analysis apparatus 1 will be explained below in reference to FIGS. 9 through 11.

### [First Typical Application of the Image Analysis Apparatus 1]

FIG. 9 is a block diagram showing a typical functional configuration of a surveillance system 81 including as one of its components the image analysis apparatus embodying the present invention.

The surveillance system 81 in FIG. 9 is made up of an imaging unit 91, an imaging signal processing unit 92, an imaging data processing unit 93, an image analysis unit 94 composed of the above-described image analysis apparatus 1 embodying the invention, and a transmission unit 95.

The imaging unit 91 is composed of an image pickup device such as CCD (charge coupled device) or CMOS (complementary metal oxide semiconductor) and lenses. Typically, the imaging unit 91 may be the surveillance camera 61 in FIG. 3. The imaging unit 91 takes images of the moving object or the like and outputs the resulting imaging signal.

The imaging signal processing unit 92 performs various image-related processes such as image correction permitting appropriate gradations, noise removal, and colorization on the imaging signal. Consequently, the imaging signal processing unit 92 outputs a digitized imaging signal, i.e., imaging data that is supplied to the imaging data processing unit 93 and image analysis unit 94.

The imaging data processing unit 93 performs a process for converting the imaging data into a format in which to distribute the data of the taken image over a network. For example, the imaging data processing unit 93 carries out a compression coding process on the imaging data.

As explained above in connection with the image analysis apparatus 1, the image analysis unit 94 analyzes the imaging data output from the imaging signal processing unit 92 as the data of the analysis image, thereby detecting an image of a moving object moving inside the designated region FS in the analysis image of interest.

The transmission unit 95 multiplexes the image data encoded by the imaging data processing unit 93 with the result of the analysis performed by the image analysis unit 94. The transmission unit 95 proceeds to transmit the multiplexed result onto the network.

### [Second Typical Application of the Image Analysis Apparatus 1]

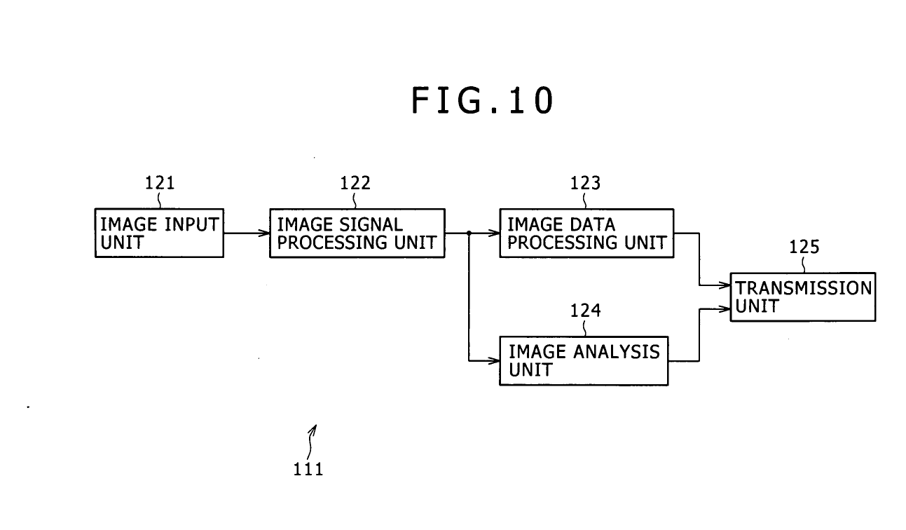

FIG. 10 is a block diagram showing a typical functional configuration of a system 111 including as one of its components the image analysis apparatus embodying the present invention, the system 111 changing the image signal coming from an external source other than the surveillance camera into a stream for distribution over the network.

The system 111 in FIG. 10 is made up of an image input unit 121, an image signal processing unit 122, an image data processing unit 123, an image analysis unit 124 composed of the above-described image analysis apparatus 1 embodying the invention, and a transmission unit 125.

The image input unit 121 inputs the image signal coming from an external source other than the surveillance camera, such as an analog camera.

As with the imaging signal processing unit 92, the image signal processing unit 122 performs various image-related processes such as image correction permitting appropriate gradations, noise removal, and colorization on the image signal. As a result, the image signal processing unit 122 outputs a digitized image signal, i.e., image data that is supplied to the image data processing unit 123 and image analysis unit 124.

The image data processing unit 123, like the imaging data processing unit 93, performs a process for converting the image data into a format in which to distribute the data of the image over the network. For example, the image data processing unit 123 carries out a compression coding process on the image data.

As explained above in connection with the image analysis apparatus 1, the image analysis unit 124 analyzes the image data output from the image signal processing unit 122 as the data of the analysis image, thereby detecting an image of a moving object moving inside the designated region FS in the analysis image of interest.

Like the transmission unit 95, the transmission unit 125 multiplexes the image data encoded by the image data processing unit 123 with the result of the analysis performed by the image analysis unit 124. The transmission unit 125 proceeds to transmit the multiplexed result onto the network.

### [Third Typical Application of the Image Analysis Apparatus 1]

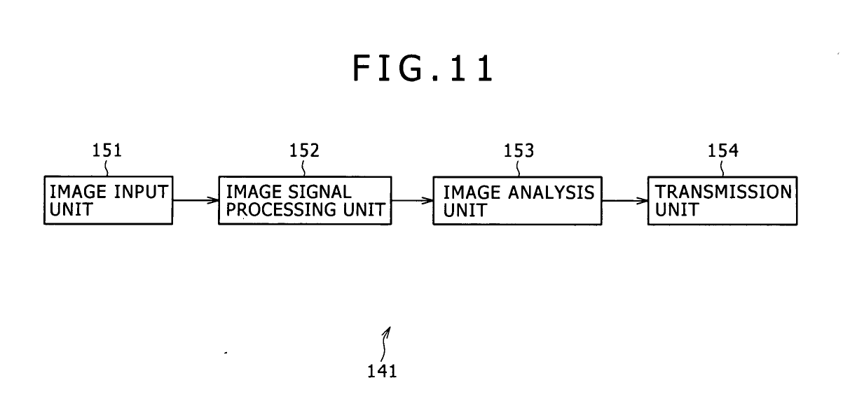

FIG. 11 is a block diagram showing a typical functional configuration of another system 141 including as one of its components the image analysis apparatus embodying the present invention.

The system 141 in FIG. 11 is a system that includes a recorder for storing processed signals regardless of the difference in format between analog and digital signals (data), a dedicated device for outputting an alarm based on the processed signals, and a personal computer.

The system 141 in FIG. 11 is made up of an image input unit 151, an image signal processing unit 152, an image analysis unit 153 composed of the above-described image analysis apparatus 1 embodying the invention, and a transmission unit 154.

As with the image input unit 121, the image input unit 151 inputs the image signal coming from an external source other than the surveillance camera.

Like the imaging signal processing unit 92 and image signal processing unit 122, the image signal processing unit 152 performs various image-related processes such as image correction permitting appropriate gradations, noise removal, and colorization on the image signal. As a result, the image signal processing unit 152 outputs a digitized image signal, i.e., image data that is supplied to the image analysis unit 153.

As explained above in connection with the image analysis apparatus 1, the image analysis unit 153 analyzes the image data output from the image signal processing unit 152 as the data of the analysis image, thereby detecting an image of a moving object moving inside the designated region FS in the analysis image of interest.

The transmission unit 154 transmits the result of the analysis coming from the image analysis unit 153 onto the network.

The first embodiment of the present invention can thus be applied to diverse fields and may also be practiced in many applications other than those described above.

For example, it was shown in the foregoing paragraphs that there are two search ranges D1 and D2 in which to search for the image of the moving object as illustrated in FIG. 3. Alternatively, the number of search ranges for the detection of the moving object image is not limited to two but may be selected as desired.

### [Typical Processing Technique Applied to Segmented Search Ranges]

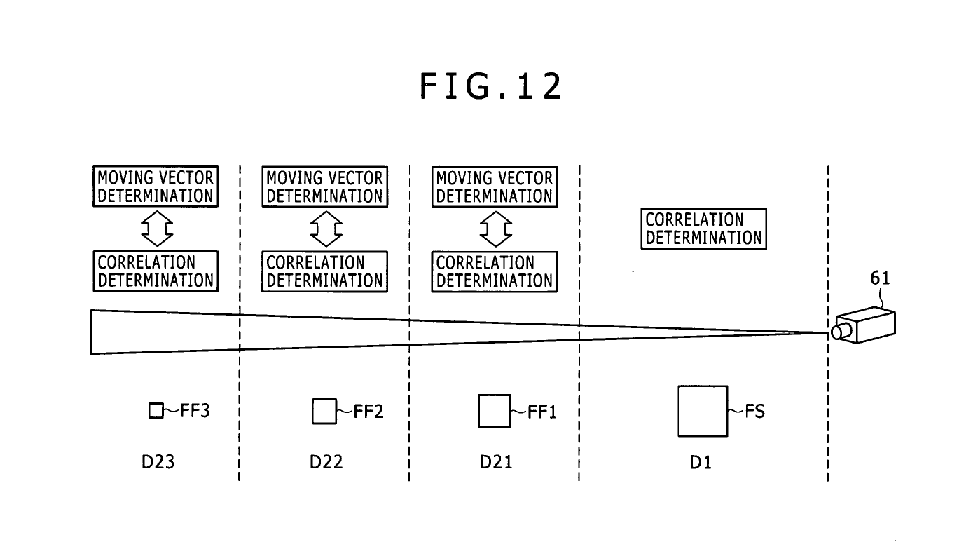

FIG. 12 is a schematic view showing a typical processing technique applicable to each of four segmented search ranges.

As shown in FIG. 12, the search range D1 at a short distance within a predetermined distance from the surveillance camera 61 is the same as the search range D1 indicated in FIG. 3. Meanwhile, the search range D2 at a long distance shown in FIG. 3 is segmented into three search ranges, i.e., a second search range D21, a third search range D22, and a fourth search range D23 in order of increasing distance from the surveillance camera 61. In each of the second search range D21, the third search range D22 and the fourth search range D23, a search is made independently for an image of a moving object. In this case, in each of the second search range D21, the third search range D22 and the fourth search range D23, it is determined independently whether the brightness of the analysis image is below a predetermined reference level. In any of the second search range D21, the third search range D22 and the fourth search range D23 where it is determined that the brightness is above the reference level, moving vector determination is adopted as the processing technique. On the other hand, in any of the second search range D21, the third search range D22 and the fourth search range D23 where it is determined that the brightness is below the reference level, correlation determination is adopted as the processing technique.

Also, as discussed above, the designated region FS is used unchanged as the detection region in the short-distance search range D1. Meanwhile, if correlation determination is adopted as the processing technique in any of the second search range D21, the third search range D22 and the fourth search range D23 where the brightness is below the reference level, the region FF smaller in size than the designated region FS is used as the detection region. In this case, the region FF for use in the second search range D21, the third search range D22 and the fourth search range D23 as the detection region takes the form of a region FF1, a region FF2 and a region FF3, respectively. The regions FF1, FF2 and FF3 each serving as the detection region diminish progressively in size in that order. That is, the farther away from the surveillance camera 61, the smaller the detection region is arranged to be in size. This arrangement permits detection of the image of a moving object that is farther away from the surveillance camera than ever.

In other words, function blocks, not shown, that are each functionally and structurally equivalent to the long-distance detection processing section 13 in FIG. 1 in principle are provided independently to deal with the second search range D21, the third search range D22 and the fourth search range D23, each of the function blocks permitting detection of the moving object in the corresponding search range.

In the case above, other techniques for detecting the moving object image may be adopted alternatively in combination with the currently used processing technique. For example, the technique of changing the resolution of the image depending on the search range may be adopted. If this technique is utilized, it is possible to apply low resolution to, say, the second search range D21 while using high resolution in the third search range D22 and the fourth search range D23. As another example, the technique of varying frame rate depending on the search range may be adopted. If this technique is utilized, it is possible to apply high frame rate to, say, the second and the third search ranges D21 and D22 while using low frame rate in the fourth search range D23.

Where various techniques for detecting the moving object image are used in suitable combination, it is possible not only to make the image analysis apparatus more robust against the disturbance such as trees but also to provide for detection of the moving object image outdoors as well as indoors.

The above-described first embodiment was shown switching the processing techniques for detecting the image of the moving object that is at a long distance in accordance with the brightness of the analysis image of interest. However, the brightness of the analysis image is not the only parameter for use with the processing technique for detecting the image of a long-distance moving object. Any other suitable parameter may be adopted instead.

### 2. Second Embodiment

### Another Functional Structure of the Image Analysis Apparatus

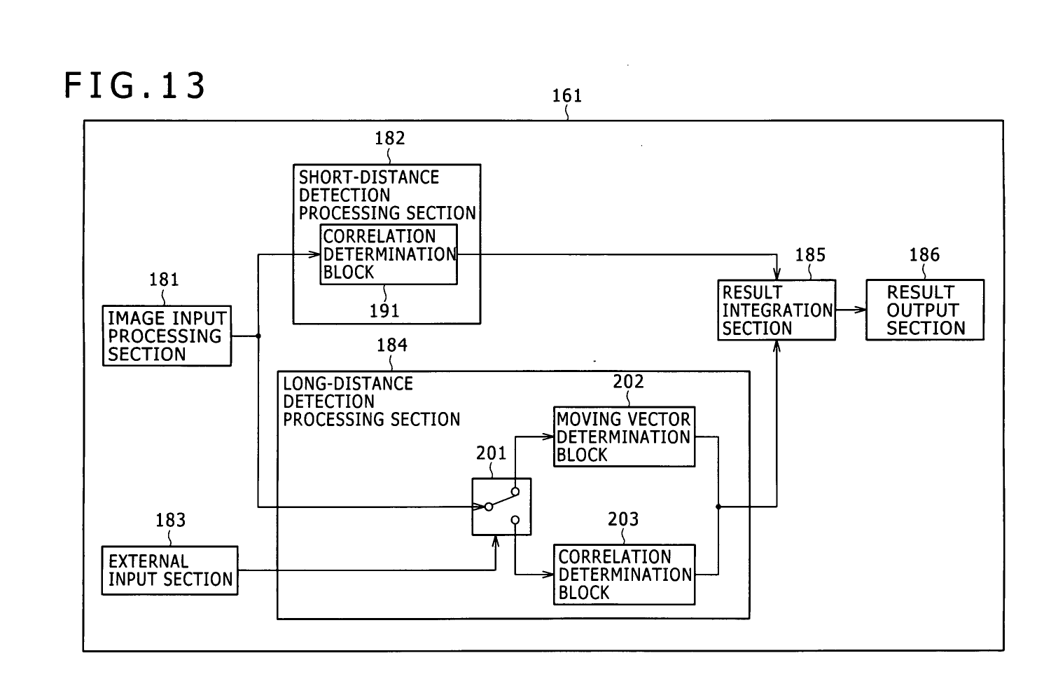

FIG. 13 is a block diagram showing a functional structure of another image analysis apparatus 161 serving as the moving object detection apparatus embodying the present invention, the image analysis apparatus 161 utilizing a parameter different from that which is used by the image analysis apparatus 1 in FIG. 1 when switching the processing techniques for detecting the image of a moving object at a long distance.

The image analysis apparatus 161 in FIG. 13 is made up of an image input processing section 181, a short-distance detection processing section 182, an external input section 183, a long-distance detection processing section 184, a result integration section 185, and a result output section 186.

The short-distance detection processing section 182 is composed of a correlation determination block 191.

The long-distance detection processing section 184 is constituted by a processing technique selection block 201, a moving vector determination block 202, and a correlation determination block 203.

Comparing the image analysis apparatus 161 in FIG. 13 with the image analysis apparatus 1 in FIG. 1 in terms of functional structure reveals that the image input processing section 181, short-distance detection processing section 182, result integration section 185, and result output section 186 are basically the same structurally and functionally as the image input processing section 11, short-distance detection processing section 12, result integration section 14, and result output section 15 in FIG. 1, respectively. It is also revealed that the components of the long-distance detection processing section 184 in FIG. 13, i.e., the processing technique selection block 201, moving vector determination block 202 and correlation determination block 203, are basically the same structurally and functionally as the processing technique selection block 32, moving vector determination block 33, and correlation determination block 34 of the long-distance detection processing section 13 in FIG. 1, respectively. That is, those components of the image analysis apparatus 161 in FIG. 13 which are described in this paragraph match the components of the image analysis apparatus 1 in FIG. 1. The matching components will not be discussed further in order to avoid redundancy.

On the other hand, the image analysis apparatus 161 in FIG. 13 is different from the image analysis apparatus 1 in FIG. 1 in the following points: that the parameter by which the processing technique selection block 32 in FIG. 1 selects the processing technique is given by the brightness determination block 31, whereas the parameter by which the processing technique selection block 201 in FIG. 13 selects the processing technique is supplied by the external input section 183. In other words, the image analysis apparatus 161 in FIG. 13 differs from its counterpart in FIG. 1 in that it has the external input section 183 replacing the brightness determination block 31 shown in FIG. 1.

The external input section 183 inputs a processing technique switching instruction from the outside and notifies the processing technique selection block 201 of the input instruction.

Based on the switching instruction given by the external input section 183, the processing technique selection block 201 selects either moving vector determination or correlation determination as the processing technique. That is, when notified of the instruction for switching to moving vector determination by the external input section 183, the processing technique selection block 201 selects moving vector determination as the processing technique and supplies the moving vector determination block 202 with the analysis image data output from the image input processing section 181. On the other hand, when notified of the instruction for switching to correlation determination by the external input section 183, the processing technique selection block 201 selects correlation determination as the processing technique and supplies the correlation determination block 203 with the analysis image data output from the image input processing section 181.

### [Specific Example of Switching the Processing Techniques]

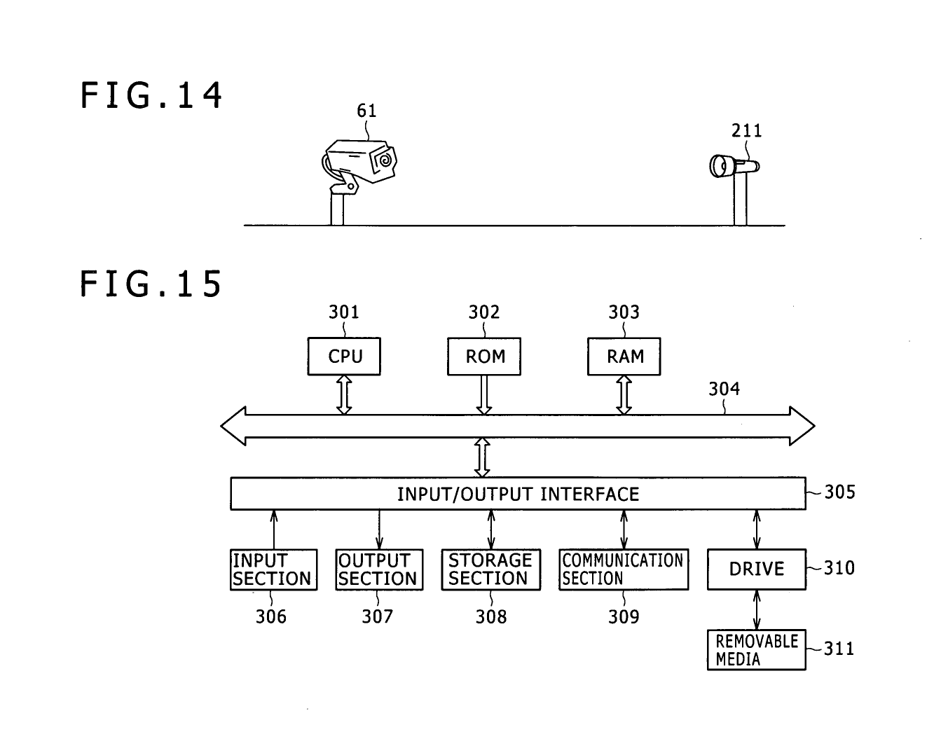

FIG. 14 is a schematic view explanatory of a specific example in which the processing techniques are switched by use of the external input section 183 described above.

It is assumed that as shown in FIG. 14, a light source 211 such as a light is located in front of the lens of the surveillance camera 61. That is, the light source 211 is supposed to be positioned in a manner facing the surveillance camera 61 from far away.

In that case, the brightness of the designated region FS for the taken image output from the surveillance camera 61 is above the reference level. Here, moving vector determination is used as the processing technique of the long-distance detection processing section 13 in the image analysis apparatus 1 of FIG. 1.

However, because the luminous image given by the light source 211 serves as the background of the taken image, there exist virtually no disturbances such as swaying trees. Judging from the other external conditions, correlation determination may then be preferable to moving vector determination. In this case, the image analysis apparatus 161 of FIG. 13 causes an instruction for switching to correlation determination to be input to the external input section 183 in order to use correlation determination as the processing technique of the long-distance detection processing section 184.

As another example, if the light from the light source 211 is blocked off, then it is determined that a moving object has moved past in front of the light source 211 and that correlation determination is therefore preferred to moving vector determination. In this case, the image analysis apparatus 161 of FIG. 13 causes the instruction for switching to correlation determination to be input to the external input section 183 so that correlation determination will be used as the processing technique of the long-distance detection processing section 184.

### [Application of the Present Invention to a Program]

The series of steps and processes described above may be executed either by hardware or by software.

In such cases, a personal computer such as one shown in FIG. 15 may be used at least as part of the above-described moving object detection apparatus.

In FIG. 15, a CPU (central processing unit) 301 performs various processes in accordance with programs recorded in a ROM (read only memory) 302 or in keeping with programs that are loaded from a storage section 308 into a RAM (random access memory) 303. The RAM 303 may also accommodate data necessary for the CPU 301 to carry out its diverse processing.

The CPU 301, ROM 302, and RAM 303 are interconnected via a bus 304. An input/output interface 305 is also connected to the bus 304.

The input/output interface 305 is connected with an input section 306 typically made up of a keyboard and a mouse and with an output section 307 usually composed of a display. The input/output interface 305 is also connected with the storage section 308 such as a hard disk and with a communication section 309 generally made up of a modem and a terminal adapter. The communication section 309 controls communications conducted with other apparatuses (not shown) over networks including the Internet.

A drive 310 is connected as needed to the input/output interface 305. A piece of removable media 311 such as magnetic disks, optical disks, magneto-optical disks or semiconductor memory may be loaded into the drive 310. The computer programs retrieved from the loaded removable medium are installed as needed into the storage section 308.

Where the series of the steps and processes above are to be executed by software, the programs constituting the software may be either retrieved from dedicated hardware of the computer in use or installed over networks or from a suitable recording medium into a general-purpose computer or like equipment capable of executing diverse functions based on the installed programs.

As shown in FIG. 15, the program recording medium carrying these programs is offered to users not only as the removable media (package media) 311 apart from their apparatuses and constituted by magnetic disks (including floppy disks), optical disks (including CD-ROM (compact disk-read only memory), DVD (digital versatile disk) and Blu-ray disks), magneto-optical disks (including MD (Mini-disk)), or semiconductor memories; but also in the form of the ROM 302 or the hard disk in the storage device 308, each accommodating the programs and incorporated beforehand in the users' apparatuses.

In this specification, the steps describing the programs stored on the storage medium represent not only the processes that are to be carried out in the depicted sequence (i.e., on a time series basis) but also processes that may be performed parallelly or individually and not necessarily chronologically.

The present invention can be applied to apparatuses which include an analysis section for analyzing image data, such as a surveillance camera, a personal computer, or a dedicated alarm output device and which are capable of detecting images of a moving object.

The present application contains subject matter related to that disclosed in Japanese Priority Patent Application JP 2010-079652 filed in the Japan Patent Office on Mar. 30, 2010, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. A moving object detection apparatus comprising:
image input processing means for inputting an analysis image composed of an image taken by a camera in order to establish a designated region inside said analysis image;
first detection processing means for detecting an image of a moving object which moves within said designated region established by said image input processing means and which is at a distance in a first range from said camera; and
second detection processing means for detecting an image of said moving object which moves within said designated region established by said image input processing means and which is at a distance in a second range from said camera, said second range being farther than said first range;
wherein said second detection processing means selectively uses either moving vector determination or correlation determination as a processing technique for detecting the image of said moving object at the distance in said second range, said moving vector determination involving determining whether there exists said moving object using a moving vector, said correlation determination involving determining whether there exists said moving object using correlations between past and current images.

2. The moving object detection apparatus according to claim 1, wherein said second detection processing means includes:
processing technique selection means for selecting either said moving vector determination or said correlation determination as said processing technique based on a predetermined parameter;
moving vector determination means configured such that if said moving vector determination is selected as said processing technique by said processing technique selection means, then said moving vector determination means detects the image of said moving object at the distance in said second range in accordance with said moving vector determination; and
correlation determination means configured such that if said correlation determination is selected as said processing technique by said processing technique selection means, then said correlation determination means detects the image of said moving object at the distance in said second range in accordance with said correlation determination.

3. The moving object detection apparatus according to claim 2, wherein
said second detection processing means includes brightness determination means for determining whether the brightness of said designated region is below a predetermined level;
if the brightness of said designated region is determined to be above said predetermined level by said brightness determination means, then said processing technique selection means selects said moving vector determination as said processing technique; and
if the brightness of said designated region is determined to be below said predetermined level by said brightness determination means, then said processing technique selection means selects said correlation determination as said processing technique.

4. The moving object detection apparatus according to claim 2, further comprising
external input means for inputting externally said parameter for use by said processing technique selection means;
wherein, based on said parameter input by said external input means, said processing technique selection means selects either said moving vector determination or said correlation determination as said processing technique.

5. The moving object detection apparatus according to claim 3, wherein
said second detection processing means has a plurality of ranges established for the distance to said moving object to be detected; and
independently in each of said plurality of ranges, said second detection processing means selects either said moving vector determination or said correlation determination as said processing technique to be used.

6. A moving object detection method comprising the steps of:
inputting an analysis image composed of an image taken by a camera in order to establish a designated region inside said analysis image;
detecting first an image of a moving object which moves within said designated region established in said image input step and which is at a distance in a first range from said camera; and
detecting secondly an image of said moving object which moves within said designated region established in said image input step and which is at a distance in a second range from said camera, said second range being farther than said first range;
wherein said second image detection step selectively uses either moving vector determination or correlation determination as a processing technique for detecting the image of said moving object at the distance in said second range, said moving vector determination involving determining whether there exists said moving object using a moving vector, said correlation determination involving determining whether there exists said moving object using correlations between past and current images.

7. A program for causing a computer to execute a control procedure comprising the steps of:
inputting an analysis image composed of an image taken by a camera in order to establish a designated region inside said analysis image;
detecting first an image of a moving object which moves within said designated region established in said image input step and which is at a distance in a first range from said camera; and
detecting secondly an image of said moving object which moves within said designated region established in said image input step and which is at a distance in a second range from said camera, said second range being farther than said first range;
wherein said second image detection step selectively uses either moving vector determination or correlation determination as a processing technique for detecting the image of said moving object at the distance in said second range, said moving vector determination involving determining whether there exists said moving object using a moving vector, said correlation determination involving determining whether there exists said moving object using correlations between past and current images.

8. A moving object detection apparatus comprising:
an image input processing section configured to input an analysis image composed of an image taken by a camera in order to establish a designated region inside said analysis image;
a first detection processing section configured to detect an image of a moving object which moves within said designated region established by said image input processing section and which is at a distance in a first range from said camera; and
a second detection processing section configured to detect an image of said moving object which moves within said designated region established by said image input processing section and which is at a distance in a second range from said camera, said second range being farther than said first range;
wherein said second detection processing section selectively uses either moving vector determination or correlation determination as a processing technique for detecting the image of said moving object at the distance in said second range, said moving vector determination involving determining whether there exists said moving object using a moving vector, said correlation determination involving determining whether there exists said moving object using correlations between past and current images.
